(19) United States
(12) Patent Application Publication
(10) Pub. No.: US 2025/0018711 A1
(43) Pub. Date: Jan. 16, 2025

(54) PRINTHEAD DEVICE WITH A ROBUST INK DISTRIBUTION SYSTEM

(71) Applicant: CANON KABUSHIKI KAISHA, Tokyo (JP)

(72) Inventor: Klaas Verzijl, Well (NL)

(21) Appl. No.: 18/771,932

(22) Filed: Jul. 12, 2024

(30) Foreign Application Priority Data
Jul. 14, 2023 (EP) 23185502.4

(51) Int. Cl. B41J 2/14; B41J 2/175

(52) U.S. Cl. CPC B41J 2/14201; B41J 2/17563; B41J 2002/14306

(57) ABSTRACT

A printhead including a droplet forming layer comprising droplet forming units, provided in a plurality of rows extending in a first direction, each droplet forming unit comprising a pressure chamber in fluid connection to outlet and inlet channels for respectively flowing fluid out of and into the pressure chamber and to a nozzle for jetting fluid by pressure change inside the pressure chamber; and two layer segments formed on top of one another in a third direction. One of the layer segments comprises outflow and inflow trenches extending continuously in a second direction perpendicular to the first and third directions and being in fluid connection to respectively outlet and inlet channels in the droplet forming layer. Another one of the layer segments comprises a staggered pattern of outflow and inflow opening channels in fluid connection to respectively the outflow and inflow trenches, when viewed in the third direction.

### BACKGROUND OF THE INVENTION

### 1. Field of the Disclosure

The disclosure relates to a printhead and to a printer comprising such a device.

### 2. Description of Background Art

EP4151416 A1 discloses a printhead comprising a droplet forming layer comprising droplet forming units, provided in a plurality of rows extending in a first direction, each droplet forming unit comprising a pressure chamber in fluid connection to an outlet channel and an inlet channel for respectively flowing fluid out of and into the pressure chamber and to a nozzle for jetting a droplet of fluid from the nozzle by means of a pressure change inside the pressure chamber. The printhead is a so-called “throughflow” printhead, wherein fluid may continuously flow through the respective pressure chamber by means of an inlet and outlet channel connected thereto, even when no droplets are being jetted from the nozzle. The continuous fluid flow reduces the chance of fluid becoming stagnant and locally degrading to a more viscous fluid inside the pressure chamber, which may result in droplets not reliably being jetted from the respective nozzle. Ink is supplied to the outlet and inlet channels via a distribution layer mounted onto the droplet forming layer, which distribution layer comprises a channel structure for flowing fluid to respectively and from the outlet and inlet channels in the droplet forming layer. EP4151416 A1 discloses wide inflow and outflow trenches to supply and remove the fluid to respectively the inlet channels and the outlet channels. The trenches run through the entire distribution layer in the third direction and have a relatively large width in the second direction.

### SUMMARY OF THE INVENTION

It is an object of the disclosure to provide an alternative printhead, preferably with an improved robustness of the distribution layer.

In accordance with the present disclosure, a printhead is provided. The printhead includes a droplet forming layer comprising droplet forming units, provided in a plurality of rows extending in a first direction, each droplet forming unit comprising a pressure chamber in fluid connection to an outlet channel and an inlet channel for respectively flowing fluid out of and into the pressure chamber and to a nozzle for jetting a droplet of fluid from the nozzle by means of a pressure change inside the pressure chamber; two layer segments formed on top of one another in a third direction, wherein a first one of layer segments comprises outflow and inflow trenches extending continuously in a second direction perpendicular to the first and third directions and being in fluid connection to respectively outlet and inlet channels in the droplet forming layer, and wherein another one of the layer segments comprises a staggered pattern of outflow opening channels and inflow opening channels in fluid connection to respectively the outflow and inflow trenches, when viewed in the third direction.

It is the insight of the inventor that long trenches running entirely through the thickness of the layer segments in the third direction reduce the structural integrity of the printhead, as the layer segments preferably act as a carrier substrate for the droplet forming layer. At least one layer segment comprises trenches for the distributing fluid in the second direction, while another layer segment is free of such trenches. Instead the latter layer segment comprises a pattern of spaced apart outflow and inflow opening channels. The pattern is staggered, allowing fluid to be supplied to the trenches without forming a trench that runs through the full thickness of the respective layer segment in the third direction. It will be appreciated that preferably the printhead is wider in the second direction than in the first direction: the numbers of parallel nozzle rows extending in the first direction is large, preferably at least 100 of such nozzle rows per inch.

The first one of the layer segments defines outflow and inflow trenches which respectively overlap and connect to rows of outlet and inlet channels extending in the second direction in the droplet forming layer. The trenches extend in the second direction over a relatively long distance, corresponding to a width of the respective layer segment in the second direction. While the trenches run substantially uninterrupted in the second direction, the staggered pattern in the other one of the layer segments ensures that over each trench outflow and/or inflow opening channels alternate with closed portions of the other one of the layer segments. When viewed from above, the staggered positions of the outflow and/or inflow opening channels result in that only a portion of the total area of an outflow flow or inflow trench is provided with respectively outflow and/or inflow opening channels, when viewed in the third direction. Since the other one of the layer segments is substantially free of trenches, it acts as a robust support substrate for the other layer segment(s) and the droplet forming layer, thereby strengthening the entire printhead. Thereby, the overall robustness of the printhead is increased. Thus the object of the present disclosure has been achieved.

### BRIEF DESCRIPTION OF THE EMBODIMENTS

More specific optional features of the disclosure are indicated in the dependent claims.

In an embodiment, the outflow opening channels and inflow opening channels are staggered, such that wall elements, which separate respective outflow opening channels and inflow opening channels, extend continuously in the second direction over a major or a substantially length of the other one of the layer segments, wherein neighboring wall elements are connected to one another via a plurality barrier elements in the other one of the layer segments, which barrier elements are respectively spaced apart from another in the second direction, preferably by an inflow or outflow opening channel. In the other of the layer segments, the outflow opening channels and inflow opening channels are positioned in respective rows extending in the second direction. In each row, the respective opening channels alternate with barrier elements in the second direction: there are outflows rows parallel to the second direction wherein barrier elements are positioned in between outflow opening channel and parallel thereto inflow rows wherein inflow opening channel are inserted in between barrier elements. An outflow opening channel adjacent or neighboring an inflow opening channel has a different position in the second direction as the said inflow opening channel to create the staggered pattern. A inflow row is separated from an outflow row by a wall element in the other of the layer segments that extends continuously in the second direction over substantially the entire width of the other one of the layer segments in the second direction. In consequence, along the first direction a pattern is formed in the other of the layer segments, such as the following:
an outflow row with outflow opening channels alternating with barrier elements in the second direction;
a wall element extending continuously in the second direction;
an inflow row with inflow opening channels alternating with barrier elements in the second direction;
a wall element extending continuously in the second direction;
an outflow row with outflow opening channels alternating with barrier elements in the second direction;
a wall element extending continuously in the second direction; Etc.

In an embodiment, the outflow and inflow opening channels extend in the third direction through the other one of the layer segments for flowing fluid in the third direction to respectively the outflow and inflow channels in the second layer segment. Preferably, the outflow and inflow opening channels are parallel to the third direction, such that the other one of the layer segments is formed as a plate with through-holes provided in a staggered pattern.

In an embodiment, the positions of the outflow and inflow opening channels in fluid connection to each other via respective pressure chambers in the second direction are different. The staggering may be achieved by offsetting the respective outflow openings channel with respect to their connected inflow opening channels in the second direction. Preferably the pattern is repeating in the second direction.

In an embodiment, a cross-section of the first and second layer segments perpendicular to the second direction is substantially constant at least along a full length of the outflow and inflow trenches in the second direction and wherein the other one of the layer segments comprises at least two different cross-sections perpendicular to the second direction which are repeated and/or alternated in the second direction, wherein in one of the cross-sections at the positions of at least a portion of the outflow and/or inflow opening channels an open channel is provided, whereas in the other one of the cross-sections a barrier element is provided at said position preventing a flow of marking material in the third direction. The cross-sections define the trenches, channels, and the wall elements separating them. In the first and second layer segments the outflow and inflow trenches, the outflow and inflow channels, preferably as well as any wall elements separating them have a constant cross-sectional area along the second direction, for at least the entire width of the trenches in the second direction. The first and second layer segments are thus constant and/or continuous in the second direction, at least with regard to the cross-sections of their channels and trenches. The other one of the layer segments is discontinuous in the second direction in at least the areas over the outflow and inflow trenches. When for example following an outflow trench, the other one of the layer segments comprises outflow opening channels over each outflow trench in fluid connection to said outflow trench alternating with barrier elements (being closed areas of the other one of the layer segments), which at those positions prevent fluid from flowing through the other one of the layer segments into the respective outflow trench. The same applies mutatis mutandis to the alternating outflow opening channels and barrier elements over each inflow trench. It will be appreciated that aspects not related to the fluid flow via trenches and channels may be varied or kept constantly independently of the features described herein. When viewed in the third direction, the open area of outlet opening channels connected a certain outlet trench is less than the total area of said outlet trench. The same applies respectively to the inlet trenches and inlet opening channels.

In an embodiment, in one of the cross-sections at the positions of the outflow channels in the first direction an open outflow opening channel is provided and at the positions of the inflow channels in the first direction an barrier element is provided, and wherein in another one of the cross-sections at the positions of the inflow channels in the first direction an open inflow opening channel is provided and at the positions of the outflow channels in the first direction a barrier element is provided. When viewed in first direction, the centers of the inflow opening channels do overlap not with the centers of the outflow opening channels. Along the second direction in the other one of the layer segments, neighboring inflow and outflow opening channels are respectively separated by barrier elements. In the second direction at least ten outflow or inflow opening channels are provided over a respective outflow or inflow trench. Preferably, the outflow and inflow opening channels in fluid connection to a respective outflow or inflow trench are aligned with one another, so that these form a row of spaced apart opening in the second direction, preferably over the respective outflow or inflow channel in the second layer segment. Thus parallel rows of respectively outflow and inflow opening channels are provided on the other one of the layer segments. The rows alternate, so that a row of inflow opening channels is positioned between two adjacent rows of outflow opening channels and/or vice versa. When viewed in the first direction, the outflow opening channels and the inflow opening channels have different positions, resulting in the staggered pattern. Preferably, outflow and inflow opening channels are aligned in alternating rows in the first direction as well. Consequently, a cross-section in the plane of the first and third direction through an outflow opening channel further intersects other outflow opening channels, but is free of inflow opening channels. A similar cross-section through an inflow opening channel further intersects other inflow opening channels, but is free of outflow opening channels. It will be appreciated that the above embodiment is exemplary and that the staggering may be achieved in different ways. Further, the above embodiment applies when each inflow and outflow opening channel in fluid connection to a respective neighboring pair of outlet and inlet channels in the droplet forming layer (with the exception of the outer outlet or inlet channels in the first direction): one may divide each outflow and inflow opening channel in multiple smaller channels, so that each inlet and and/or outlet channel connected to a single one of such smaller outflow or inflow channel openings.

In an embodiment, the other one of the layer segments is positioned on the side of the first and/or second layer segments facing away from the droplet forming layer. The other one of the layer segments is positioned at the fluid reservoir side of the printhead. The first one of the layer segments is between the other one of the layer segments and the droplet forming layer, so that fluid flows between the droplet forming units and the other one of the layer segments via the first one of the layer segments.

In an embodiment, a plurality of outflow opening channels and inflow opening channels respectively overlaps each outflow and inflow trench, and wherein positions of outflow opening channels in the first and second directions are different from positions of the inflow opening channels. Above each outflow trench a plurality of outflow opening channels are provided which are separated from one another in the second direction by barrier elements. The barrier elements are preferably solid, closed areas of the other one of the layer segments where no channel in the third direction has been formed, in contrast to the outflow and inflow opening channels. While over each outflow and inflow trench, fluid moves through the other one of the layer segments against or in the third direction, in the second layer segment these separated fluid flows join together in the respective outflow or inflow channel, which extend uninterrupted in the second direction.

In an embodiment, the printhead comprises a distribution layer mounted onto the droplet forming layer, which distribution layer comprises a channel structure for flowing fluid to respectively and from the outlet and inlet channels in the droplet forming layer. The distribution layer is mounted on the droplet forming layer. Preferably, to assemble the printhead the distribution layer and the droplet forming layer are formed separately and then mounted onto one another in a subsequent bonding step. In a first embodiment, the one and the other one of the layer segments are formed in the distribution layer and the droplet forming layer is free of any trenches. In a second embodiment, the other one of the layer segments is formed in the droplet forming layer, which includes to the inlet and outlet restrictors in connection with their respective trenches.

In a preferred embodiment, the printhead comprises three layer segments which together form a channel structure which defines the outflow and inflow trenches and the staggered pattern of outflow and inflow openings. As previously indicated, the respective layer segment nearest the droplet jetting units may be formed as part of the droplet forming layer or as part of the distribution layer. Preferably, the layer segment nearest the droplet jetting units or the middle layer segments in between the other layer segments forms the first one of the layer segments. The respective layer segment most remote from the droplet jetting devices in the third direction preferably forms the other one of the layer segments.

In an embodiment, the first one of the layer segments are mounted on the droplet forming layer in a stacked configuration and the outflow and inflow trenches alternate in the first direction. Every outflow trench is positioned between a pair of inflow trenches and/or vice versa, with exception of the outer trenches in the first direction. All trenches are preferably parallel to the second direction and extend through the entire thickness of the second layer segment in the third direction.

In an embodiment, the second layer segment is positioned between the first and third layer segments and comprises:
outflow channels each positioned respectively overlapping one of the outflow trenches;
a damper channel;
a inflow channel separated from the damper channel by a wall element, wherein the damper channel and the inflow channel overlap the inflow trench when viewed in the third direction.

Preferably, a width of the inflow trench is greater than that of the outflow trench measured in the first direction. The damper channel and the inflow channel both extend along the full width of the inflow trench in the second direction. Viewed in the third direction, the damper channel, the inflow channel, and the wall element between them overlap the inflow trench. In a compact embodiment, the damper channel, the inflow channel, and the wall element between them are positioned within the footprint of the inflow trench when viewed in the third direction. Preferably, the outflow trench, the inflow trench, the out flow channel and the inflow channel are all open on both ends in the third direction. The damper channel is preferably closed by a wall formed by the third layer segment on the side of said third layer segment.

In an embodiment, a filter-damper film is provided between the first and second layer segments, wherein the filter-damper film locally seals the damper channel to form a flexible damper, and wherein the filter-damper film at the inflow channel is configured as a filter for filtering marking material flowing from the inflow channel to the inflow trench. The filter-damper film seals the damper channel, so that a closed chamber is formed in the second layer segment: fluid is unable to flow into the chamber. The filter-damper film is flexible, so that is able to deform into and away from the damper channel. Thereby, the filter-damper film can locally absorb pressure waves in the fluid, preventing these from passing into pressure chambers and disrupting operation of the respective droplet forming unit.

In an embodiment, the outflow opening channels in the third layer segment overlap respective outflow channels in the second layer segment when viewed in the third direction, and wherein the inflow opening channels overlap the inflow channel. When viewed from above the outflow opening channels are within the footprint of the respective outflow channel over which these are positioned. The total open area formed by the outflow opening channels over a single, respective outflow channel and/or outflow trench, is smaller than that of the outflow channel and/or outflow trench. This is due to the spaced apart positioned of the outflow opening channels in the second direction due the presence of the barrier elements. Similarly, the total open area formed by the inflow opening channels over a single, respective inflow channel is smaller than that of the inflow channel.

In an embodiment, the outflow trenches, the inflow trenches, the damper channel, the outflow channel, and the inflow channel extend parallel to the second direction and each comprise a substantially constant cross-section along the second direction. The width in the first direction and depth in the third direction of these trenches and channels is substantially constant over the entire second direction, with the exception of the outer edges.

In an embodiment, in the third layer segment barrier elements and outflow opening channels are positioned alternatingly in the second direction over the outflow channel and barrier elements and inflow opening channels are positioned alternatingly in the second direction over the inflow channel. In the droplet forming layer the inlet and outlet channel preferably alternate, so that neighboring pairs of respectively outlet and inlet channels are formed. Preferably, the outlet and inlet channels in the first direction are arranged in a ABBAABBA . . . pattern. In the second direction, outlet and inlet channels are more preferably respectively aligned in rows of the same type. In that second direction, an ABABABABA . . . pattern of outflow opening channels and barrier elements is provided. The barrier elements form a closed surface between neighboring outflow opening channels in the third layer segment. The same applies mutatis mutandis to the inflow opening channels. In a preferred embodiment, the outflow opening channels are positioned over the outflow channel, which outflow channel is preferably positioned over a (pair of) outlet channels. The inflow opening channels are preferably positioned besides the inlet channels in the first direction, when viewed in the second or third direction, so that the damper channel is positioned over an inlet channel or pair of inlet channels. The inflow opening channel connects to the inflow channel besides the damper channel in the first direction, so that fluid flows underneath the damper from the inflow channel to the inlet channel.

In an embodiment, wherein the second and third layer segments have been integrally formed. The second layer segment is formed from a different substrate (e.g. a plate or sheet), while the second and third later segments are formed from the same substrate. The different substrates are adhered on opposite sides of the filter-damper film.

The present disclosure further relates to a printer comprising a printhead as described above. The printer is preferably an inkjet printer.

The present disclosure further relates to a printhead comprising:
a droplet forming layer comprising droplet forming units, provided in a plurality of rows extending in a first direction, each droplet forming unit comprising a pressure chamber in fluid connection to an outlet channel and an inlet channel for respectively flowing fluid out of and into the pressure chamber and to a nozzle for jetting a droplet of fluid from the nozzle by means of a pressure change inside the pressure chamber;
a first, a second, and a third layer segment formed on top of one another in a third direction, wherein:
   the first layer segment comprises outflow and inflow trenches extending in a second direction perpendicular to the third direction and being in fluid connection to respectively outlet and inlet channels in the droplet forming layer;
   the second layer segment comprises:
   outflow channels each positioned respectively overlapping one of the outflow trenches when viewed in the third direction;
   a damper channel;
   an inflow channels separated from the damper channel by a wall element, wherein the damper channel and the inflow channel overlap the inflow trench when viewed in the third direction;
   the third layer segment comprises outflow opening channels and inflow opening channels in fluid connection to respectively the outflow and inflow trenches;
   a filter-damper film is provided between the first and second layer segments, wherein the filter-damper film locally seals the damper channel to form a flexible damper, and wherein the filter-damper film at the inflow channel is configured as a filter for filtering marking material flowing from the inflow channel to the inflow trench. Thus is provided a compact printhead design with a relatively small foo print.

In an embodiment, the first layer segment is mounted on the droplet forming layer, and the second layer segment is positioned between the first and the third layer segments. In another embodiment, the outflow and inflow trenches alternate in the first direction. In a further embodiment, the outflow channels are each positioned respectively overlapping one of the outflow trenches. In an additional embodiment, the outflow and inflow trenches extend continuously in a second direction perpendicular to the first and third directions.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic, cross-sectional view of a printhead according to the present disclosure;

FIG. 2 is a schematic, perspective view of a printhead according to the present disclosure;

FIG. 3 is a first enlarged, schematic, cross-sectional view the printhead in FIGS. 1 and 2;

FIG. 4 is a second enlarged, schematic, cross-sectional view the printhead in FIGS. 1 and 2;

FIG. 5 is an enlarged, schematic, cross-sectional view illustrating a first method for manufacturing the printhead in FIGS. 1 and 2;

FIG. 6 is an enlarged, schematic, cross-sectional view illustrating a second method for manufacturing the printhead in FIGS. 1 and 2;

FIG. 7 is a schematic, top-down view of a second layer segment of a printhead in FIGS. 1 and 2;

FIG. 8 is a schematic, top-down view of a second layer segment of a printhead in FIGS. 1 and 2;

FIG. 9 is a schematic, top-down view of a third layer segment of a printhead in FIGS. 1 and 2;

FIG. 10 is a schematic, top-down view of a third layer segment of a printhead in FIGS. 1 and 2;

FIG. 11 is a schematic, top-down view of a second layer segment of a printhead in FIGS. 1 and 2; and

FIG. 12 is a schematic, top-down view of a third layer of a printhead in FIGS. 1 and 2.

### DETAILED DESCRIPTION OF THE EMBODIMENTS

The present disclosure will now be described with reference to the accompanying drawings, wherein the same reference numerals have been used to identify the same or similar elements throughout the several views.

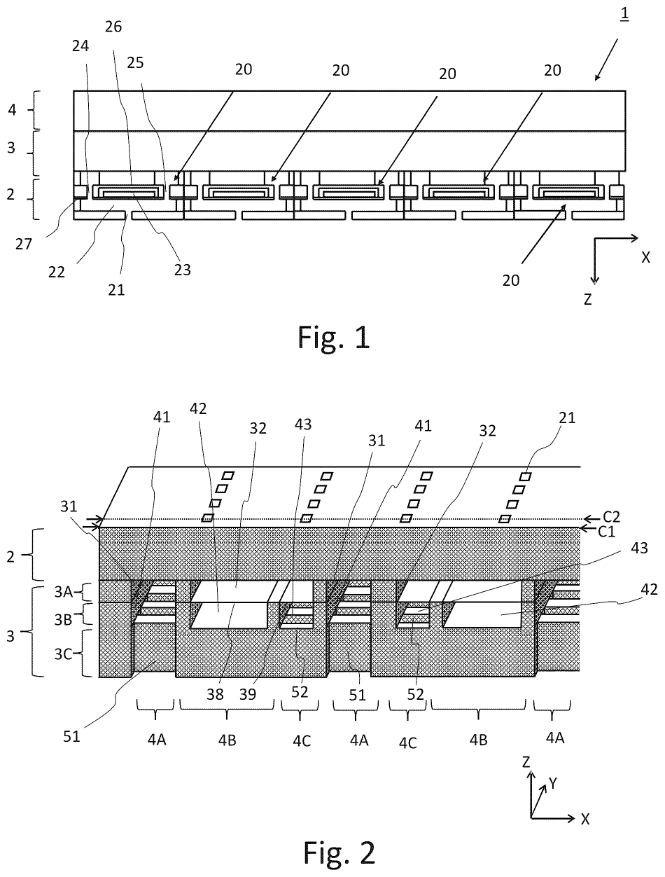

FIG. 1 illustrate a printhead 1 configured for jetting droplets of a fluid marking material. The printhead 1 has a layered, planar structure comprising a plurality of layers 2, 3 extending in the first and second directions X, Y, which layers 2, 3 are stacked onto one another in the third direction Z. The third direction Z is perpendicular to the first and second directions X, Y and preferably the direction in which droplets are jetted from the printhead 1. The printhead 1 comprises a plurality of droplet forming units 20 arranged besides one another in a row in the first direction X. As illustrated in FIG. 2, multiple rows of droplet forming units 20 may be positioned besides one another in the second direction Y.

Each droplet forming unit 20 comprises a nozzle 21 in fluid connection to a pressure chamber 22. An actuator 23 is arranged to generate a pressure pulse or wave in the pressure chamber 22, so that a droplet is jetted from the nozzle 21. In FIG. 2 the actuator 23 is a piezo-electric element separated from the pressure chamber 22 by a flexible membrane 27. By applying a voltage to the piezo-electric actuator 23, it is deformed, causing the membrane 27 to flex into and/or away from the pressure chamber 22. This results in a pressure pulse in the fluid inside the pressure chamber 22, causing a droplet to be jetted from the nozzle 21. Other means for generating the pressure pulse may be applied as well, such as for example a thermal inkjet actuator or a ‘bubble jet’ based actuator.

Ink is supplied to the pressure chamber via an inlet channel 25. An outlet channel 24 is provided, so that marking material may continue to flow through the pressure chamber 22 without jetting a droplet from the nozzle 21. In the inlet and outlet channels 24, 25 are both formed as narrow restrictors channels extending the third direction Z. The inlet and out channel 24, 25 are provided on opposite sides of the actuator 22. The actuator 22 is positioned inside an actuator cavity 26, which is sealed on one side by the membrane 27. The actuator cavity 23 is positioned in between the inlet channel 25 and the outlet channel 24. The top openings of the inlet and outlet channels 24, 25 in FIG. 1 are provided in the top surface of the droplet forming layer 2. The inlet and outlet channels 24, 24 are preferably parallel to the third direction Z and, when viewed in the third direction Z, overlap the pressure chamber 22. Marking material is distributed to the different inlet and outlet channels 24, 25 via the distribution layer 3. The third layer 3 comprises a channel structure to distribute marking material from a reservoir (not shown) to all the different inlet channel 25. The channel structure is also configured to receive marking material from the outlet channel 25, so that such marking material may be returned to the pressure chambers 22. The outlet and inlet channels 24, 25 are provided, so that at each wall element between two neighboring pressure chambers 22 in the first direction X, a pair of neighboring outlet or inlet channels 24, 25 is provided.

The channel structure of the distribution layer 3 is illustrated in FIG. 2. In FIG. 2 the droplet forming layer 2 with the droplet forming units 20 is on top. Multiple nozzles 21 are provided in parallel rows extending in the first direction X. In the second direction a large number of such rows are positioned besides one another. The distribution layer 3 is a filter-damper distribution layer 3 arranged to further filter any marking material being supplied to the inlet channels 25 and to at least partially dampen any pressure pulses travelling towards and/or from inlet channels 24. The distribution layer 3 comprises three layer segments 3A, 3B, 3C stacked on top of another in the third direction Z. In the first direction X, the distribution layer 3 comprises a pattern of outflow segments 4A, damper segments 4B, and inflow segments 4C.

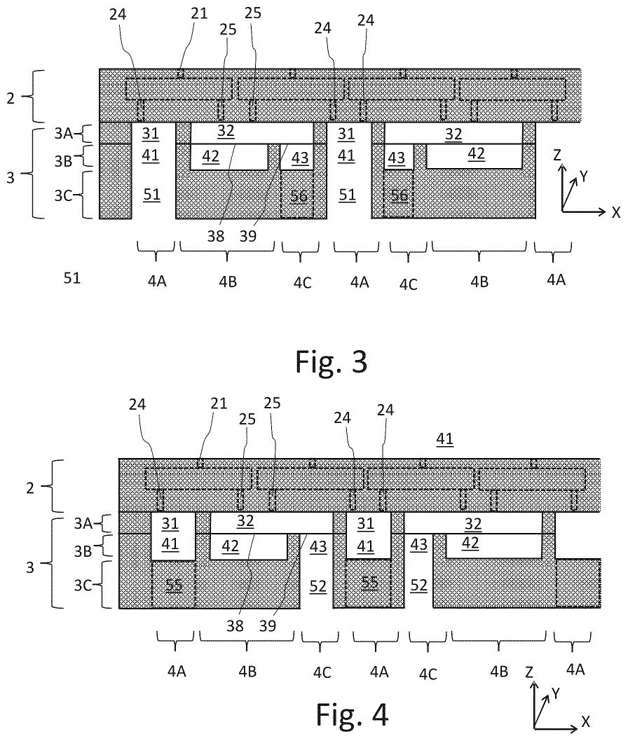

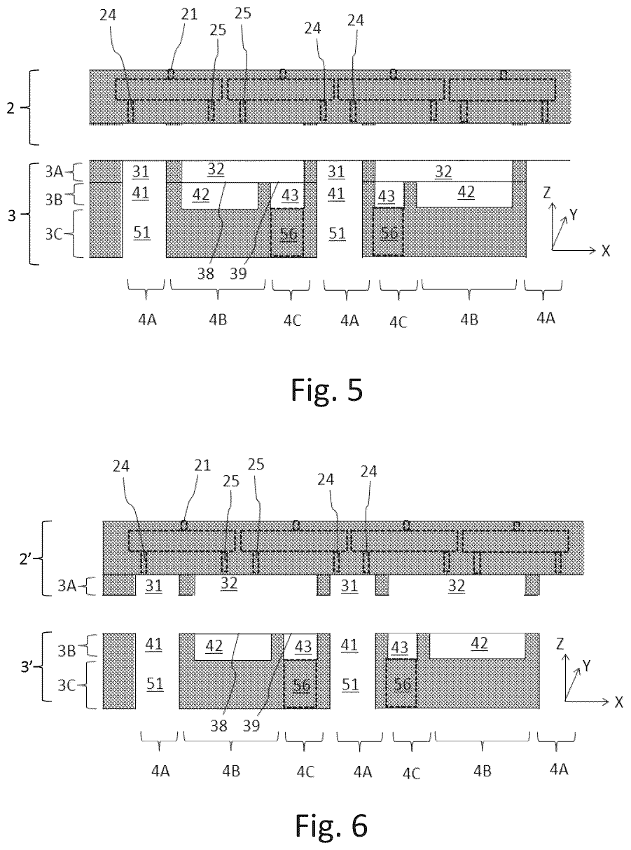

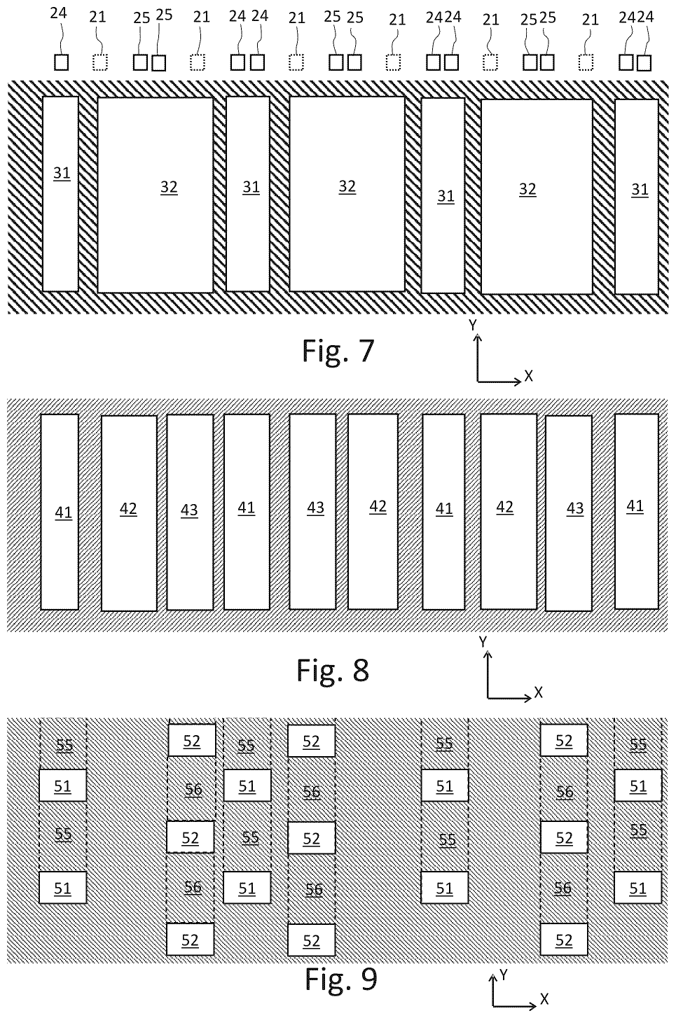

The second layer segment 3A distributes marking material in the second direction Y across different nozzles 21 aligned in the second direction Y. Thereto a plurality of parallel, spaced apart trenches 31, 32 are provided in the second layer segment 3A. FIGS. 3 and 4 illustrate a cross-sectional view of the printhead 1 in FIG. 2 with cross-sections along the XZ-plane at respectively cross-section lines C1 and C2. The respective cross-section of the first layer segment 3A is substantially constant in the second direction Y, as also illustrated in FIG. 5. The second layer segment 3A contacts the surface of the droplet forming layer 2, which comprises the openings of the inlet and outlet channels 24, 25. The second layer segment 3A comprises alternating inflow and outflow trenches 31, 32. The inflow and outflow trenches 31, 32 are parallel channels in the second direction Y, which are separated from one another by wall elements. The wall elements prevent marking material in one trench 31, 32 from flowing into another in the distribution layer 2. The width of the outlet trench 31 in the first direction X is smaller than that of the inlet trench 32. The outlet trenches 31 are positioned, so that these overlap outlet channels 24, but not with the inlet channels 25. The inlet trenches 32 do not overlap the outlet channels 24, but do overlap the inlet channels 25. The relative positions of the inlet and outlet channels 24, 25 are alternating, so that pairs of neighboring outlet channels 24 and neighboring pairs of inlet channels 25 are formed, with the exception of the outer sides of the printhead 1 in the first direction X. With the exception of said outer sides, an outlet trench 31 preferably overlaps with a pair of neighboring outlet channels 24 and an inlet trench 32 overlaps with a pair of neighboring inlet channels 25.

A second layer segment 3B is mounted on a side of the second layer segment 3A opposite the side of the droplet forming layer 2. As seen in FIGS. 3, 4, and 8, the cross-section of the second layer segment 3B is substantially constant in the Y-direction, at least between the ends of the trenches 41-43. A damper-filter film is provided between the first and second layer segments 3A, 3B, which has been locally processed to form a filter and/or opening. The second layer segment 3B comprises outflow channels 41, which overlap the outflow trenches 31 in the second layer segment 3A. The respective portions of the damper-filter film between an adjacent outflow trench 31 and an outflow channel 41 have been processed to form an opening, such that marking material may flow substantially unhindered from the outflow trench 31 into the outflow channel 41. Over each inflow trench 31, the second layer segment positions a damper channel 42 and an inflow channel 43. The damper channel 41 is separated from the inflow channel 43 by a wall element positioned between the two. The damper channel 42 is sealed by the damper-filter film, so that no marking material can flow into the damper channel 41. The damper-filter is flexible, so that the sealed off damper channel 42 forms a damper 38 arranged to absorbed pressure pulses travelling through the inlet trench 32. The damper channel 42 is positioned overlapping the inlet channels 25, so that a sealing portion of the damper-filter membrane faces the inlet channels 25. By preventing a pressure pulse from one pressure chamber 22 from affecting the pressure in a neighboring pressure chamber 22, the reliability and/or accuracy of the printhead 1 is improved. Besides the damper channel 42 in the first direction X, the inflow channel 43 is provided overlapping a portion of the inflow trench 32, which portion itself is not overlapping with the damper channel 42. At the end of the inflow channel 43 facing the inflow trench 32, the filter-damper film has been process to comprises a large number of small openings, so that the filter-damper film there acts as a filter arranged to remove particulates, such as gas bubbles or dirt from the marking material. The damper channel 42 and the inflow channel 43 alternate in their relative positions, so that with respect to an outflow channel 41 positioned over a pair of outlet channels 24, the adjacent damper channel 42 and inflow channel 43 are provided mirror symmetrically with respect to said an outflow channel 41.

The second layer segment 3B has been integrally formed with a third layer segment 3C. The third layer segment 3C is positioned on the second layer segment 3B on the opposite side of the second layer segment 3A. In contrast to the first and second layer segments 3A, 3B, the channel structure of the third layer segment 3C is discontinuous in the second direction Y. Where the first and second layer segments 3A, 3B comprise long trenches 31, 32, 42 and channels 41, 43 extending a full width of all nozzles in the second direction Y, the third layer segment 3C comprises discrete inflow and outflow opening channels 51, 52, illustrated as discrete vertical openings in FIGS. 3, 4, and 9. The third layer segment 3C comprises a repeating pattern of alternating cross-sections, which are respectively illustrated in FIGS. 3 and 4. Along the first cross-sectional plane C1, the outflow opening channels 51 are positioned, so that these overlap the outflow channel 41 and the outflow trench 31 in the third direction Z. The outflow opening channels 51 do not form long channels or trenches, but have a length in the second direction Y smaller than ten times, preferably smaller than four times, a distance between neighboring nozzles in the second direction Y. As illustrated in FIG. 4, at the second cross-sectional plane C2, a barrier element is provided at the position of the outflow opening channel 51. Similarly, the inflow opening channel 52 are formed as a trench filled with alternating barrier elements and opening channels. The positions of the inflow opening channels 52 in both the first and second directions X, Y are different from those of the outflow openings channels 51. The inflow and outflow opening channels 51, 52 are spaced apart from one another in the first and second directions X, Y, resulting in a discrete pattern of openings on the surface of the distribution layer 2, which faces away from the droplet forming units 20. Since the third layer segment 3C is free of long trenches or channels, it provides structural strength to the distribution layer 2, allowing it be manufactured and assembled into a printhead 1 without the risk of breakage.

FIG. 5 illustrates a first embodiment of a method of forming a printhead 1, wherein the first layer segment 3A is formed as part of the distribution layer 3. The distribution layer 3 and droplet forming layer 2 are formed in separate processes to be bonded together thereafter. FIG. 6 illustrates a different embodiment, wherein the first layer segment 3A is formed in the droplet forming layer 2′. In this latter embodiment, the droplet jetting layer 2′ is etched to comprise the inflow and outflow trenches 31, 32 over and in connection with the respective inlet and outlet restrictors 24, 25. The distribution layer 2′ herein comprises the layer segments 3B, 3C.

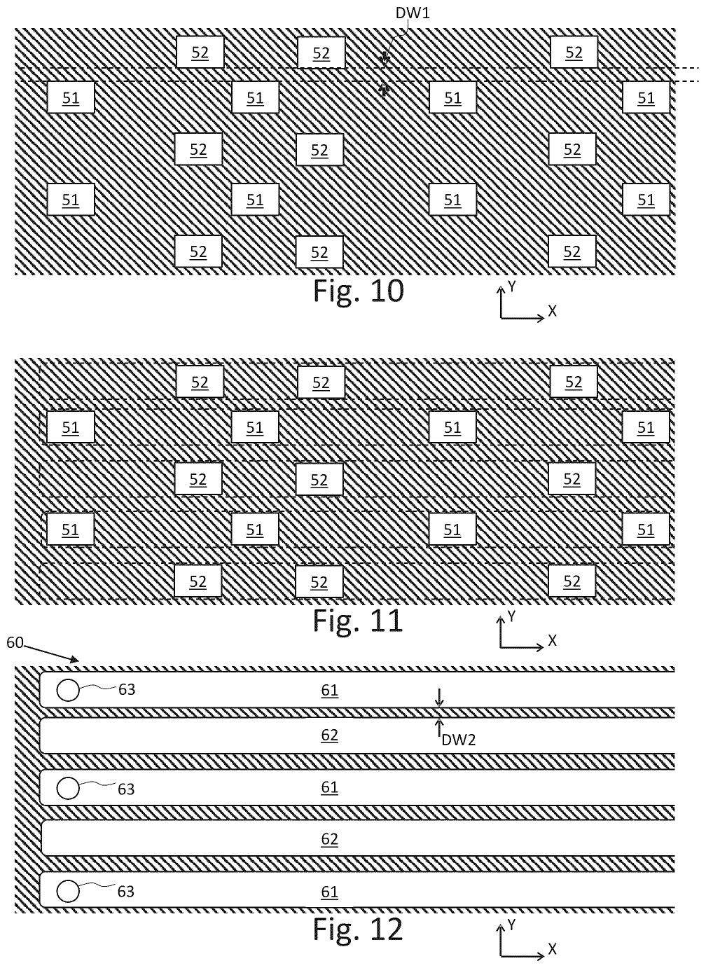

FIGS. 10 to 12 illustrate the mounting of a third layer 4 in the form of a supply layer 60. The supply layer 60 in FIG. 12 comprises a plurality of supply and return channels 61, 62 extending in the first direction X. Each channel 61, 62 comprises an opening 63 for the supply or removal of ink from the respective channel 61, 62. The return openings are preferably positioned opposite to the supply openings in the first direction X. A supply channel 61 is to be positioned overlapping a row of inflow opening channels 52, while a return channel 62 overlaps a row of outflow opening channels in the first direction X, as shown in FIG. 11. The dam width (DW1 in FIG. 8) between a row of outflow opening channels 51 and a row of inflow opening channels 52 has been selected to be smaller than a corresponding dam width DW2 (or vice versa) to allow for play between the relative positioning of the third layer 4 on the distribution layer 3. Since the layers 3, 4 are glued together by means of adhesive, the play achieved by the reduced dam width DW1 prevents adhesive from being spread into the opening channels 51, 52. Thereby blockage of a channel during manufacturing may be prevented.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects. While herein overlapping may be interpreted as including any manner of at least partially overlaying two objects when viewed in a certain direction, it will be appreciated that in a preferred embodiment, the above mentioned overlapping objects also fit within each other's footprint.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

This application claims the benefit of European Patent Application No. 23185502.4, filed Jul. 14, 2023, which is hereby incorporated by reference herein in its entirety.

1. A printhead comprising:
a droplet forming layer comprising droplet forming units, provided in a plurality of rows extending in a first direction, each droplet forming unit comprising a pressure chamber in fluid connection to an outlet channel and an inlet channel for respectively flowing fluid out of and into the pressure chamber and to a nozzle for jetting a droplet of fluid from the nozzle by means of a pressure change inside the pressure chamber; and
two layer segments formed on top of one another in a third direction, wherein one of the layer segments comprises outflow and inflow trenches extending continuously in a second direction perpendicular to the first and third directions and being in fluid connection to respectively outlet and inlet channels in the droplet forming layer, and wherein another one of the layer segments comprises a staggered pattern of outflow opening channels and inflow opening channels in fluid connection to respectively the outflow and inflow trenches, when viewed in the third direction.

2. The printhead according to claim 1, wherein the outflow opening channels and inflow opening channels are staggered, such that wall elements which separate respective the outflow opening channels and inflow opening channels extend continuously in the second direction over a major or a substantially length of the other one of the layer segments, wherein neighboring wall elements are connected to one another via a plurality barrier elements in the other one of the layer segments, which barrier elements are respectively spaced apart from another in the second direction.

3. The printhead according to claim 1, wherein a cross-section of the one of the layer segments perpendicular to the second direction is substantially constant at least along a full length of the outflow and inflow trenches in the second direction, and wherein the other of the layer segments comprises at least two different cross-sections perpendicular to the second direction which are repeated and/or alternated in the second direction, wherein in one of the cross-sections at the positions of at least a portion of the outflow and/or inflow opening channels an open channel is provided, whereas in the other one of the cross-sections a barrier element is provided at said position preventing a flow of marking material in the third direction.

4. The printhead according to claim 3, wherein in one of the cross-sections at the positions of the outflow channels in the first direction an open outflow opening channel is provided and at the positions of the inflow channels in the first direction an barrier element is provided, and wherein in another one of the cross-sections at the positions of the inflow channels in the first direction an open inflow opening channel is provided and at the positions of the outflow channels in the first direction a barrier element is provided.

5. The printhead according to claim 1, wherein the other one of the layer segments is positioned on the side of the one of the layer segments facing away from the droplet forming layer.

6. The printhead according to claim 1, wherein a plurality of outflow opening channels and inflow opening channels respectively overlaps each outflow and inflow trench, and wherein positions of outflow opening channels in the first and second directions are different from positions of the inflow opening channels.

7. The printhead according to claim 1, wherein the first one of the layer segments are mounted on the droplet forming layer and the outflow and inflow trenches alternate in the first direction.

8. The printhead according to claim 7, wherein a second layer segment is positioned between a first and a third layer segments and comprises:
outflow channels each positioned respectively overlapping one of the outflow trenches;
a damper channel; and
an inflow channel separated from the damper channel by a wall element, wherein the damper channel and the inflow channel overlap the inflow trench when viewed in the third direction.

9. The printhead according to claim 8, wherein a filter-damper film is provided between the first and second layer segments, wherein the filter-damper film locally seals the damper channel to form a flexible damper, and wherein the filter-damper film at the inflow channel is configured as a filter for filtering marking material flowing from the inflow channel to the inflow trench.

10. The printhead according to claim 8, wherein the outflow opening channels in the third layer segment overlap respective outflow channels in the second layer segment when viewed in the third direction, and wherein the inflow opening channels overlap the inflow channel.

11. The printhead according to claim 8, wherein outflow trenches, the inflow trenches, the damper channel, the outflow channel, and the inflow channel extend parallel to the third second direction and each comprise a substantially constant cross-section along the second direction.

12. The printhead according to claim 11, wherein in the third layer segment barrier elements and outflow opening channels are positioned alternatingly in the second direction over the outflow channel and barrier elements and inflow opening channels are positioned alternatingly in the second direction over the inflow channel.

13. The printhead according to claim 1, wherein the second and third layer segments have integrally formed.

14. A printer comprising a printhead according to claim 1.

15. A printhead comprising:
a droplet forming layer comprising droplet forming units, provided in a plurality of rows extending in a first direction, each droplet forming unit comprising a pressure chamber in fluid connection to an outlet channel and an inlet channel for respectively flowing fluid out of and into the pressure chamber and to a nozzle for jetting a droplet of fluid from the nozzle by means of a pressure change inside the pressure chamber; and
a first, a second, and a third layer segment formed on top of one another in a third direction, wherein:
the first layer segment comprises outflow and inflow trenches extending in a second direction perpendicular to the third direction and being in fluid connection to respectively outlet and inlet channels in the droplet forming layer;
the second layer segment comprises:
outflow channels each positioned respectively overlapping one of the outflow trenches when viewed in the third direction;
a damper channel;
an inflow channels separated from the damper channel by a wall element, wherein the damper channel and the inflow channel overlap the inflow trench when viewed in the third direction;
the third layer segment comprises outflow opening channels and inflow opening channels in fluid connection to respectively the outflow and inflow trenches; and
a filter-damper film is provided between the first and second layer segments, wherein the filter-damper film locally seals the damper channel to form a flexible damper, and wherein the filter-damper film at the inflow channel is configured as a filter for filtering marking material flowing from the inflow channel to the inflow trench.

16. The printhead according to claim 15, wherein first layer segment is mounted on the droplet forming layer, and the second layer segment is positioned between the first and the third layer segments.

17. The printhead according to claim 15, wherein the outflow and inflow trenches alternate in the first direction.

18. The printhead according to claim 15, wherein the outflow channels are each positioned respectively overlapping one of the outflow trenches.

19. The printhead according to claim 15, wherein the outflow and inflow trenches extend continuously in a second direction perpendicular to the first and third directions.
